(19) United States
(12) Patent Application Publication
(10) Pub. No.: US 2023/0189231 A1
(43) Pub. Date: Jun. 15, 2023

(54) COMMUNICATION APPARATUS

(71) Applicant: Sercomm Corporation, Taipei City (TW)

(72) Inventors: Meng-Chien CHIANG, Taipei City (TW); Ben LIN, Taipei City (TW)

(21) Appl. No.: 18/063,733

(22) Filed: Dec. 9, 2022

Related U.S. Application Data
(60) Provisional application No. 63/289,175, filed on Dec. 14, 2021.

(51) Int. Cl. H04W 72/0453; H04W 72/563

(52) U.S. Cl. CPC H04W 72/0453; H04W 72/563; H04W 84/12

(57) ABSTRACT

A communication apparatus disposed outdoors, comprises the following elements. A first communication module performing a Low-Power Wide-Area-Network (LPWAN) communication with at least one end device in a first frequency band. A second communication module coupled to the first communication module, comprising a signal processor, a chime module; and a wireless communication circuit. The wireless communication circuit performs at least one wireless communication in a second frequency band. The first communication module is communicatively coupled to a network server through the second communication module, the first communication module transmits and/or receives a LPWAN package in a first timeslot, the wireless communication circuit of the second communication module transmits and/or receives a wireless package in a second timeslot, and the signal processor configures the wireless communication circuit to have a higher priority than the first communication module when transmitting and/or receiving the wireless package.

This application claims the benefit of U.S. provisional application Ser. No. 63/289,175, filed Dec. 14, 2021, the entirety of which is incorporated herein by reference.

### TECHNICAL FIELD

This disclosure is related to a communication apparatus, and particularly, related to a communication apparatus capable of performing a Low-Power Wide-Area Network (LPWAN) communication, a wireless communication and a doorbell function.

### BACKGROUND

As the progress of communication technology, to meet requirements of communication performance with long distance, low power and low cost, several LPWAN communication standards have been proposed, e.g., Long Range (LoRa) and Sigfox.

FIG. 1 is a schematic diagram illustrating a network configuration of a LPWAN gateway 10. Referring to FIG. 1, the LPWAN gateway 10 is communicatively coupled to a network server 300 through a network backhaul (e.g., an Ethernet backhaul, a wireless LAN (WLAN) backhaul and a 3G backhaul). The LPWAN gateway 10 may communicate with at least one end device 500.

When communicating with the end device 500, the LPWAN gateway 10 transmits LPWAN signals to and/or receives LPWAN signals from the end device 500. Traditionally, the LPWAN gateway 10 is located indoors, e.g., disposed within a building 400. Accordingly, LPWAN signals conveyed between the LPWAN gateway 10 and the end device 500 are likely interfered by a wall 410 of the building 400, which may deteriorate the communication performance.

Moreover, the LPWAN signals are easily interfered by other wireless signals and the performance and the reliability of the LPWAN communication are further degraded.

### SUMMARY

According to an aspect of the present disclosure, a communication apparatus is provided. The communication apparatus is disposed outdoors and comprises a first communication module and a second communication module. The first communication module is configured to perform a Low-Power Wide-Area-Network (LPWAN) communication with at least one end device in a first frequency band. The second communication module is coupled to the first communication module and comprises a signal processor, a chime module; and a wireless communication circuit. The wireless communication circuit is configured to perform at least one wireless communication in a second frequency band. The first communication module is communicatively coupled to a network server through the second communication module, the first communication module is configured to transmit and/or receive a LPWAN package in a first timeslot, the wireless communication circuit of the second communication module is configured to transmit and/or receive a wireless package in a second timeslot, and the signal processor configures the wireless communication circuit to have a higher priority than the first communication module when transmitting and/or receiving the wireless package.

### BRIEF DESCRIPTION OF THE DRAWINGS

FIG. 1 (prior art) is a schematic diagram illustrating a network configuration of a LPWAN gateway.

FIG. 2A is a schematic diagram illustrating a network configuration of a communication apparatus according to an embodiment of the present disclosure.

FIG. 2B is a block diagram illustrating the network configuration of an embodiment of the communication apparatus in FIG. 2A.

FIG. 3A is a block diagram of the communication apparatus according to an embodiment of this disclosure.

FIG. 3B is a block diagram of an embodiment of the chime module in

FIG. 3A.

FIG. 3C is a block diagram of an embodiment of the wireless communication circuit in FIG. 3A.

FIG. 4 is a schematic diagram illustrating an exemplary mechanism for reducing the LPWAN-WLAN interference and the LPWAN-CBRS interference between the first communication module and the second communication module.

FIGS. 5A and 5B are schematic diagrams illustrating another exemplary mechanism for reducing the LPWAN-WLAN interference and the LPWAN-CBRS interference between the first communication module and of the second communication module.

FIG. 6 is a schematic diagram illustrating an embodiment of a triggering event for the communication apparatus.

FIG. 7A is a perspective view of the communication apparatus according to another embodiment of the present disclosure.

FIG. 7B is a perspective view of the communication apparatus according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

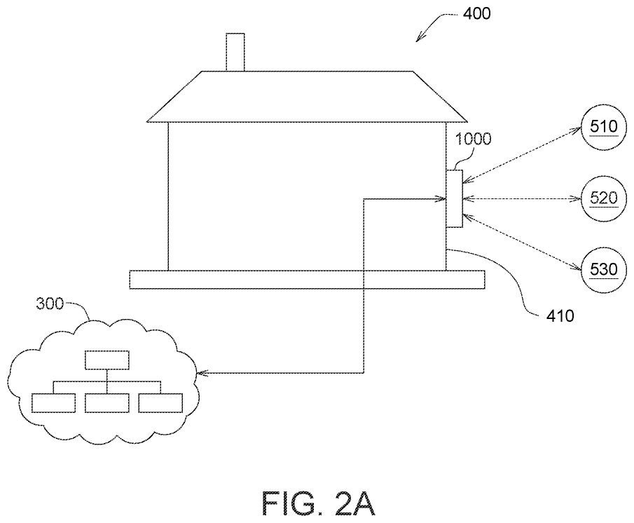

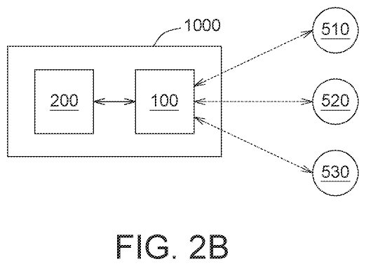

FIG. 2A is a schematic diagram illustrating a network configuration of a communication apparatus 1000 according to an embodiment of the present disclosure. Referring to FIG. 2A, the communication apparatus 1000 may perform communications with one or more Low-Power Wide-Area Network (LPWAN) end devices, e.g., three LPWAN end devices 510, 520 and 530 in a wireless manner. Furthermore, the communication apparatus 1000 is communicatively coupled to the network server 300 through the network backhaul.

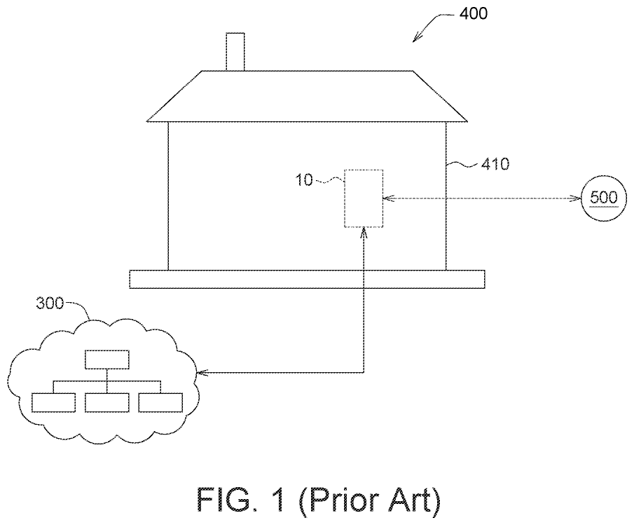

Unlike the traditional LPWAN gateway 10 of FIG. 1 which is located indoors, the communication apparatus 1000 of the present disclosure is located outdoors. For example, the communication apparatus 1000 may be disposed on an outer surface of the wall 410 of the building 400. Accordingly, LPWAN signals conveyed between the communication apparatus 1000 and the LPWAN end devices 510-530 may be free of interference caused by the wall 410, and the communication apparatus 1000 may have a better communication quality with the LPWAN end devices 510-530.

FIG. 2B is a block diagram illustrating the network configuration of the communication apparatus 1000 in FIG. 2A. Referring to FIG. 2B, the communication apparatus 1000 includes a first communication module 100 and a second communication module 200. The first communication module 100 includes a LPWAN gateway for performing a LPWAN communication with at least one of the LPWAN end devices 510-530, e.g., receiving and/or transmitting LPWAN signals. For example, the first communication module 100 may achieve an effective transmission distance of approximately 10 km with at least one of the LPWAN end devices 510-530. In one embodiment, the first communication module 100 performs a function of virtual currency mining by providing the LPWAN gateway functions.

The LPWAN end devices 510-530 may be fixed or portable respectively. In one example, the LPWAN end devices 510-530 may be respectively a LPWAN tag which may transmit LPWAN signals to the first communication module 100, and the locations of the LPWAN end devices 510-530 may therefore be tracked. In another example, the LPWAN end devices 510-530 may respectively be a LPWAN sensor which monitors the status of the ambient environment, e.g., the temperature, the noise and the air quality.

The first communication module 100 is coupled to the second communication module 200. The second communication module 200 includes a smart-doorbell device which performs a chime function and a video function and/or an audio function. In other words, the communication apparatus 1000 integrates a LPWAN gateway (i.e., the first communication module 100) with a smart-doorbell device (i.e., the second communication module 200) to obtain hybrid functions including the LPWAN communication, the chime function, the video function and/or the audio function.

Furthermore, the second communication module 200 also performs functions of wireless communications. For example, the second communication module 200 may perform wireless communications with the network server 300. Hence, the first communication module 100 may be communicatively coupled to the network server 300 through the second communication module 200, by utilizing the wireless communications performed by the second communication module 200.

Although the first communication module 100 and the second communication module 200 are illustrated as two separate blocks in FIG. 2B, a part or all of the first communication module 100 may be integrated with a part or all of the second communication module 200. For example, the first communication module 100 may be an internal circuit which is embedded in the second communication module 200.

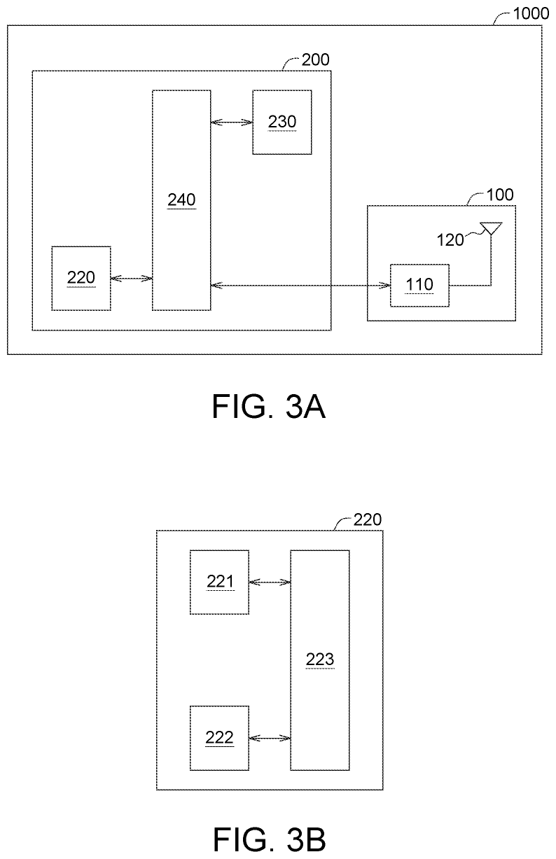

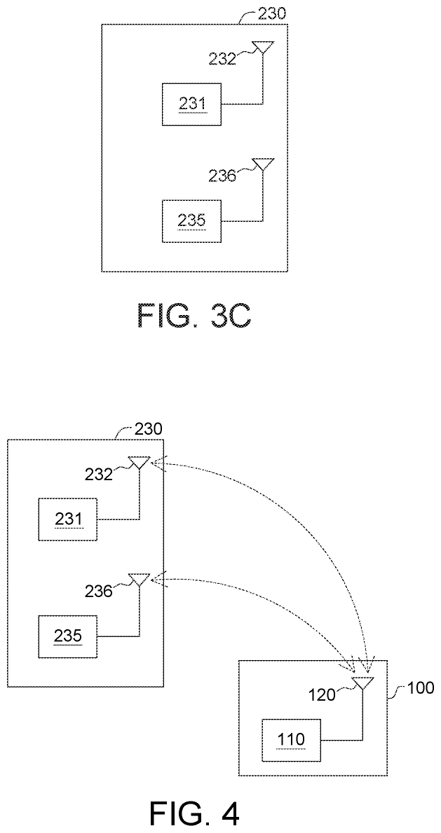

FIG. 3A is a block diagram of the communication apparatus 1000 according to an embodiment of this disclosure. Referring to FIG. 3A, the communication apparatus 1000 includes the first communication module 100 and the second communication module 200. The first communication module 100 includes a LPWAN transceiver 110 and an LPWAN antenna 120 for performing the LPWAN gateway functions. The LPWAN transceiver 110 is configured to modulate the baseband signals and convert the modulated signals into RF signals (as the LPWAN signals) for transmitting through the LPWAN antenna 120. The LPWAN transceiver 110 is also configured to covert RF signals received from the LPWAN antenna 120 into baseband signals for performing demodulation. The LPWAN transceiver 110 may transmit the demodulated signals to the second communication module 200 for further processing.

The LPWAN antenna 120 is configured to transmit and/or receive LPWAN signals in a first frequency band. For example, the first frequency band may be selected from one or more of 300 MHz, 500 MHz, 868 MHz and 908 MHz.

On the other hand, the second communication module 200 includes a signal processor 240, a chime module 220 and a wireless communication circuit 230. The signal processor 240 serves to manage the operations of the first communication module 100 and the second communication module 200. The LPWAN transceiver 110 of the first communication module 100 is coupled to the signal processor 240.

The chime module 220 is configured to perform a chime function, a video function and/or an audio function. Also referring to FIG. 3B (which is a block diagram of the chime module 220), the chime module 220 includes an audio module 221, a video module 222 and a control module 223. The audio module 221 may include a microphone and a speaker to process audio input signals and audio output signals. The video module 222 may include a camera to process image signals. The control module 223 may receive chime triggering events and configure the audio module 221 and the video module 222 to function accordingly, e.g., capturing audio/video input signals, generating audio output signals, and communicating with the signal processor 240.

Referring to FIG. 3A again, the wireless communication circuit 230 is configured to perform one or more wireless communications, e.g., wireless LAN (WLAN) communications, wireless MAN (WMAN) communications and 3G/4G/5G mobile communications. In one example, the wireless communication circuit 230 may communicate with the network server 300 through at least one of the wireless communications. Hence, the first communication module 100 is capable of communicatively coupling to the network server 300 through the second communication module 200, by utilizing the wireless communications performed by the wireless communication circuit 230.

The wireless communication circuit 230 is coupled to the signal processor 240. In the embodiment in FIG. 3C (which is a block diagram of the wireless communication circuit 230), the wireless communication circuit 230 includes a WLAN transceiver 231, a WLAN antenna 232, a Citizens-Broadband-Radio-Service (CBRS) transceiver 235 and a CBRS antenna 236. The WLAN transceiver 231 and the WLAN antenna 232 are configured to perform the “WLAN communication in second frequency band(s), e.g., 2.4 GHz and 5 GHz. On the other hand, the CBRS transceiver 235 and the CBRS antenna 236 are configured to perform a CBRS communication in a third frequency band, e.g., 3.5 GHz. In another embodiment, the wireless communication circuit 230 may include only the WLAN transceiver 231 and the WLAN antenna 232 for performing WLAN communication, or may include only the CBRS transceiver 235 and the CBRS antenna 236 for performing the CBRS communication.

In one embodiment, the LPWAN transceiver 110 and the LPWAN antenna 120 perform the LPWAN communication to convey the LPWAN signals in the first frequency band of 868 MHz or 908 MHz. Furthermore, the WLAN transceiver 231 and the WLAN antenna 232 perform the WLAN communication to convey WLAN signals in the second frequency band of 2.4 GHz. Moreover, the CBRS transceiver 235 and the CBRS antenna 236 perform the CBRS communication to convey CBRS signals in the third frequency band of 3.5 GHz. Accordingly, the harmonics of the LPWAN signals in the second frequency band will likely interfere with the WLAN signals. Likewise, the harmonics of the LPWAN signals in the third frequency band will likely interfere with the CBRS signals. Vice versa, the harmonics of the WLAN signals and the CBRS signals would also interfere with the LPWAN signals and cause a performance degradation of the LPWAN communication. The communication apparatus 1000 has mechanisms to reduce the interference between the LPWAN communication and the WLAN communication (referred to as “LPWAN-WLAN interference”) and the interference between the LPWAN communication and the CBRS communication (referred to as “LPWAN-CBRS interference”).

FIG. 4 is a schematic diagram illustrating an exemplary mechanism for reducing the LPWAN-WLAN interference and the LPWAN-CBRS interference between the first communication module 100 and the wireless communication circuit 230 of the second communication module 200. In one example, the polarization of the LPWAN antenna 120 and the polarization(s) of the WLAN antenna 232 and/or the CBRS antenna 236 are configured such that the polarization of the LPWAN antenna 120 is orthogonal to the polarization(s) of the WLAN antenna 232 and/or the CBRS antenna 236.

The LPWAN antenna 120 is configured to have a first polarization. Furthermore, the WLAN antenna 232 and/or the CBRS antenna 236 are configured to have a second polarization. The first polarization is configured to be orthogonal to the second polarization.

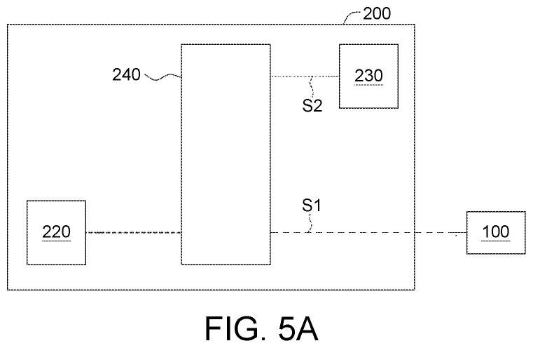

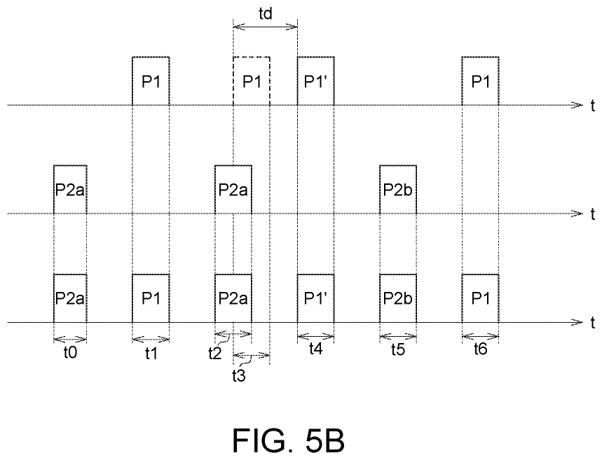

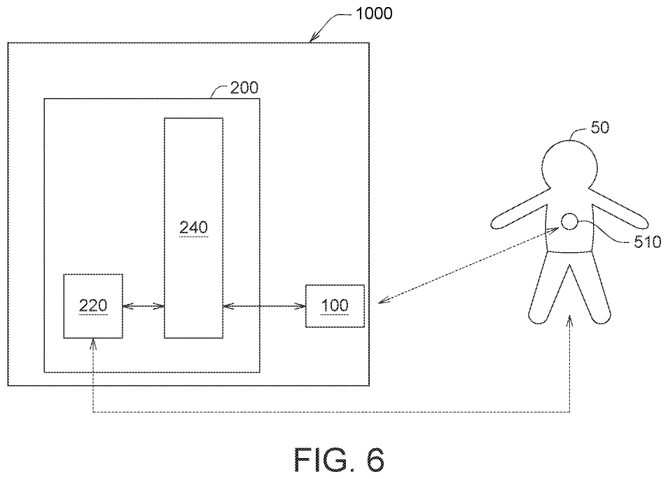

FIGS. 5A and 5B are schematic diagrams illustrating another exemplary mechanism for reducing the LPWAN-WLAN interference and/or the LPWAN-CBRS interference between the first communication module 100 and the wireless communication circuit 230 of the second communication module 200. First, referring to FIG. 5A, the first communication module 100 is configured to receive a LPWAN package P1 associated with the LPWAN communication, and the LPWAN package P1 is transmitted to the signal processor 240 of the second communication module 200 through a signal path 51. Then, the LPWAN package P1 is processed by the signal processor 240 and transmitted to the network server 300 by utilizing the wireless communication circuit 230 through a signal path S2. Furthermore, the wireless communication circuit 230 is configured to transmit a WLAN package P2a associated with WLAN communication and/or a CBRS package P2b associated with the CBRS communication.

To avoid the collision between the LPWAN package P1 and the WLAN package P2a or the CBRS package P2b, transmission/reception times for LPWAN package P1, the WLAN package P2a or the CBRS package P2b are adjusted as a time-multiplexing manner. For example, referring to FIG. 5B, a first WLAN package P2a is transmitted/received in a timeslot t0, and a first LPWAN package P1 is transmitted/received in a timeslot t1, where the first LPWAN package P1 does not collide with the first WLAN package P2a. In case that, another LPWAN package P1 transmitted/received in a timeslot t3 may likely collide with the WLAN package P2a and/or the CBRS package P2b transmitted/received in a timeslot t2 (i.e., there is a collision between the LPWAN communication and the WLAN communication or the CBRS communication), this LPWAN package P1 is assigned with a priority lower than the WLAN package P2a and/or the CBRS package P2b. That is, when there is a collision between the LPWAN communication and the WLAN communication or the CBRS communication, the WLAN package P2a and the CBRS package P2b have a higher priority in transmission/reception. For example, the first communication module 100 is configured to delay the transmission time (i.e., related to the timeslot t3) of the second LPWAN package P1 by a duration td, such that the delayed LPWAN package P1′ will be transmitted in a timeslot t4, which is separated from the second WLAN package P2a in view of the time domain.

FIG. 6 is a schematic diagram illustrating an embodiment of a triggering event for the communication apparatus 1000. Referring to FIG. 6, a triggering event related to the LPWAN end device 510 may be triggered by the LPWAN communication between the first communication module 100 and the LPWAN end device 510. For example, the first communication module 100 may receive the LPWAN signals transmitted by the LPWAN end device 510, and the signal processor 240 may determine the location of the LPWAN end device 510 according to the received LPWAN signals. When the signal processor 240 determines the LPWAN end device 510 approaches with a distance shorter than a threshold distance Dth, a triggering event related to the LPWAN end device 510 may be detected.

The LPWAN gateway functions of the first communication module 100 and the chime module 220 of the second communication module 200 may further be combined to achieve more complicated operations. In another example, a triggering event related to the LPWAN end device 510 may trigger the audio and/or video function(s) performed by the chime module 220. The LPWAN end device 510 is carried by a remote user 50, and the signal processor 240 may determine the location of the LPWAN end device 510 by the LPWAN signals. When the signal processor 240 determines the LPWAN end device 510 approaches with a distance shorter than the threshold distance Dth, the signal processor 240 configures the video module 222 to record images of the remote user 50 or configures the audio module 221 to generate sounds. In another embodiment, when a predefined motion (e.g., raising a hand) of the remote user 50 is detected, a triggering event may be detected by the chime module 220.

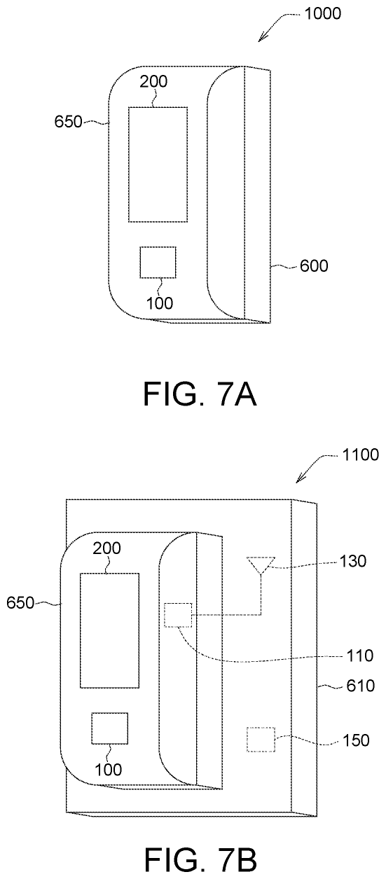

FIG. 7A is a perspective view of the communication apparatus 1000 according to an embodiment of the present disclosure. Referring to FIG. 7A, the communication apparatus 1000 further includes a casing 650 and a bracket 600. The casing 650 accommodating the first communication module 100 and the second communication module 200 may be detachably attached to a bracket 600. The bracket 600 may be mounted on the outer surface of the wall (not shown in FIG. 7A), such that the communication apparatus 1000 is disposed outdoors.

FIG. 7B is a perspective view of a communication apparatus 1100 according to another embodiment of the present disclosure. The communication apparatus 1100 of FIG. 7B is similar to the communication apparatus 1000 of FIG. 7A, except that, the bracket 610 of the communication apparatus 1100 of FIG. 7B has an enlarged capacity. In addition, the communication apparatus 1100 further includes an external antenna 130 and an external power module 150. The bracket 610 has a larger capacity than the bracket 600 shown in FIG. 7A, such that the external antenna 130 and the external power module 150 may be embedded in the bracket 610.

The external antenna 130 is coupled to the LPWAN transceiver 110, the WLAN transceiver 231 and/or the CBRS transceiver 235 for providing a better transmission/reception capability. The external antenna 130 has a greater sensitivity, such that the transmission distance for the LPWAN communication is further increased. Furthermore, the external power module 150 is coupled to the first communication module 100 and/or the second communication module 200. The external power module 150 serves as a power supply for the first communication module 100 and/or the second communication module 200 with an extended lifetime.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A communication apparatus disposed outdoors, comprising:
a first communication module, configured to perform a Low-Power Wide-Area-Network (LPWAN) communication with at least one end device in a first frequency band; and
a second communication module, coupled to the first communication module and comprising:
a signal processor;
a chime module; and
a wireless communication circuit, configured to perform at least one wireless communication in a second frequency band,
wherein, the first communication module is communicatively coupled to a network server through the second communication module, the first communication module is configured to transmit and/or receive a LPWAN package in a first timeslot, the wireless communication circuit of the second communication module is configured to transmit and/or receive a wireless package in a second timeslot, and the signal processor configures the wireless communication circuit to have a higher priority than the first communication module when transmitting and/or receiving the wireless package.

2. The communication apparatus according to claim 1, wherein the second communication module is configured to perform a wireless LAN (WLAN) communication in the second frequency band, and a harmonic of WLAN signals associated with the WLAN communication locates in the first frequency band.

3. The communication apparatus according to claim 2, wherein the first communication module further comprises an LPWAN antenna and the second communication module further comprises a WLAN antenna, the LPWAN antenna is configured to have a first polarization orthogonal to a second polarization of the WLAN antenna.

4. The communication apparatus according to claim 1, wherein the second communication module is configured to perform a Citizens-Broadband-Radio-Service (CBRS) communication in the second frequency band, and a harmonic of CBRS signals associated with the CBRS communication locates in the first frequency band.

5. The communication apparatus according to claim 4, wherein the first communication module further comprises a LPWAN antenna and the second communication module further comprises a CBRS antenna, the LPWAN antenna is configured to have a first polarization orthogonal to a second polarization of the CBRS antenna.

6. The communication apparatus according to claim 1, wherein the chime module is configured to perform a chime function, a video function and audio function.

7. The communication apparatus according to claim 6, wherein the signal processor determines a location of the at least one end device by receiving LPWAN signals of the at least one end device by the first communication module, and the second communication module tracks the location of the at least one end device by the video function.

8. The communication apparatus according to claim 1, further comprising:
a bracket, adapted to hold the first communication module and the second communication module; and
an external antenna, embedded in the bracket and coupled to the first communication module.

9. The communication apparatus according to claim 8, further comprising:
a power module, embedded in the bracket and coupled to the first communication module and the second communication module.
